(19) United States
(12) Patent Application Publication
(10) Pub. No.: US 2004/0213869 A1
(43) Pub. Date: Oct. 28, 2004

(54) Mold for composite milling blanks

(76) Inventor: Ward Crisp Whitaker, Tampa, FL (US)

Correspondence Address: Ward C. Whitaker, DMD, 5200 N. Armenia Avenue, Tampa, FL, 33603, US

(21) Appl. No.: 10/274,480

(22) Filed: Oct. 21, 2002

(51) Int. Cl. B29C 33/38

(52) U.S. Cl. 425/470; 249/134; 264/19; 249/54; 249/83; 425/174.4

(57) ABSTRACT

There are currently milling machines in dental laboratories that take blank blocks of ceramic and mill them into replacement teeth based upon CAD specifications. However, no option currently exists to make the replacement teeth out of anything but ceramic. Thus, I have invented a molded form to make composite blank blocks which are less expensive than ceramic blocks and thus offer an option for the patient.

### BACKGROUND OF THE INVENTION

In my dental practice and adjoining lab, I use a Sirona CEREC milling machine that takes blocks (blanks) of ceramic and mills them into teeth based upon the specifications programmed into the attached computer aided design unit. The problem is that not all patients want a ceramic tooth. Some want a tooth made of less expensive composite material. However, there is no source to buy composite blanks of the material that I desire.

### BRIEF SUMMARY OF THE INVENTION

So, what I did is carve molds out of a hardened block of caulk. The block of caulk measures 20 mm wide×20 mm long×20 mm deep. The mold carved out of the middle of the block measures 8 mm wide×12 mm long×20 mm deep in one instance. The mold size can vary depending upon the desire of the dentist or lab technician. After packing the composite material into the mold, I insert a metal mandrel/dowel (5 mm×20 mm) 8 mm into the end of the composite and then light cure the mold/composite/dowel for the time recommended on the packaging of the composite material. Any type of curing could occur based upon the recommendation of the manufacturer of the composite. After the material is light cured, I remove the dowel/composite from the mold and have a blank composite ready for milling. I then insert the blank into the mill using the dowel and let the mill run according to program to make a desire tooth.

1. I have invented molded forms to make composite blank blocks for use in a CAD/CAM machine for milling replacement teeth.
